(19) United States
(12) Patent Application Publication
(10) Pub. No.: US 2009/0265190 A1
(43) Pub. Date: Oct. 22, 2009

(54) System for classification and assessment of preferred risks

(76) Inventors: Thomas R. Ashley, Stamford, CT (US); Laura D. Vecchione, White Plains, NY (US)

Correspondence Address: Robert E. Cannuscio;DRINKER BIDDLE & REATH LLP, One Logan Square, 18th & Cherry Streets, Philadelphia, PA, 19103-6996, US

(21) Appl. No.: 11/019,047

(22) Filed: Dec. 20, 2004

Related U.S. Application Data
(60) Provisional application No. 60/531,871, filed on Dec. 23, 2003.

(51) Int. Cl. G06Q 40/00

(52) U.S. Cl. 705/4

(57) ABSTRACT

A method of evaluating a set of risk assessment rules for an insurance product is provided. The method includes the steps of providing a set of risk assessment rules, applying the risk assessment rules to at least a portion of a test population to generate a classified population, deriving a mortality estimate for each member of the classified population, and determining a cumulative result for each preferred category. The risk assessment rules define a plurality of preferred categories for an insurance product.

### RELATED APPLICATION

This application is related to and claims priority from U.S. Provisional Patent Application No. 60/531,871, filed Dec. 23, 2003, entitled “System for Classifying Data into Preferred Risk Categories”, which application is incorporated herein by reference in its entirety.

### FIELD OF THE INVENTION

The invention relates to the field of life insurance and more specifically to a system for classifying and assessing preferred risk categories.

### BACKGROUND OF THE INVENTION

The design of a life insurance product includes specification of multiple categories of risk, such as preferred, standard, and substandard. The definition of each category refers to any of multiple criteria that relate to risk, such as blood pressure, serum cholesterol level, or a medical condition such as diabetes. The choice of determinants of each class results in segmentation of the applicant pool into subgroups of different size and range of mortality risk. The number of risk classes and the boundaries or limits vary from product to product within and between different insurance companies.

A need exists to project the effect of the choice of criteria on the segmentation and mortality risk that result from any given configuration, and to test the effects of modification of the criteria.

Insurance policies are priced through what is known as an underwriting procedure. Underwriters use various criteria to determine the proper price, or more accurately, the proper risk to attribute to a particular applicant for insurance. The companies issuing the insurance policy usually require their underwriters to utilize prescribed criteria when evaluating an applicant for insurance. The criteria are used to place the applicant into select risk categories, such as high risk, medium risk or lower risk.

In order to determine the accuracy of the underwriting process, an insurance company will typically conduct periodic audits of the policies that it issues. Conventional auditing processes for underwriting activities is done manually. A predetermined number of policies are selected representing a random grouping of insured applicants. For example, an underwriting audit may only include less than one hundred samples out of thousands of policies. The policies are then manually audited by an individual auditor who applies the insurance companies criteria for attributing risk to the insured. If the auditor determines that the insurer should have been placed into a different risk category, the policy is considered to have been improperly underwritten.

Manual auditing has several drawbacks. First, manual auditing limits the number of underwriting activities that can be effectively reviewed and used to gauge underwriting performance. Manual auditing also may not result in an accurate assessment of the underwriting process. A small amount of policies that are determined to be “improperly issued” may not signal an error when spread throughout a companies underwriters, but may suggest a critical problem when they are associated with one region or one underwriter. Since the manual auditing process is time consuming, the results may not be available immediately. As such, it may not be possible to investigate any errors further for quite some time.

Also, a manual audit involves the subjective evaluation of some classification parameters by the auditors. As a consequence, two auditors may not provide the same evaluation of the same file.

Therefore, a need exists for an improved underwriting audit mechanism that provides a cost effective and efficient way to quantify the impact of underwriting errors and to determine error patterns in underwriting activities.

### SUMMARY OF THE INVENTION

The present invention is directed to a system and method to simulate the underwriting process. In one aspect, a method of evaluating a set of risk assessment rules for an insurance product is provided. The method includes the steps of providing an interface to a user configured to aid in programming the set of risk assessment rules and applying the risk assessment rules to at least a portion of a test population to generate a classified population. The risk assessment rules define a plurality of preferred categories for an insurance product. The method also includes the steps of deriving a mortality estimate for each member of the classified population and determining a cumulative result for each preferred category.

In various embodiments, the method can include the step of filtering the test population to create a subset of the test population. The risk assessment rules can be applied to the subset of the test population. The step of deriving a mortality estimate can include deriving a standard mortality estimate and modifying the standard mortality estimate in response to at least one parameter associated with each member of the classified population.

Additionally, the test population can be modified to include at least one parameter in addition to a set of parameters associated with original test population. The additional parameter can be related to mortality.

In one aspect, a static historical population of life insurance applicants serves as a surrogate for future applicants. The actual value of each relevant underwriting criterion is known for each member of the historical population. The desired set of risk assessment rules is programmed and applied to the population, simulating the classification into underwriting risk classes. Comparison of different underwriting rules applied to the same historical population yields different projections of the size and mortality of each configuration of risk classes.

The underwriting sample data can include information related to a purchase decision of the applicant. The method can also include the step of analyzing a set of applicants that declined to purchase the insurance project and the step of suggesting a modification to the risk assessment rules in response to the analysis step.

In another aspect, the invention facilitates proper and consistent actions on applicants that fall outside of formal requirements for a risk class. For example, the blood pressure might be 1 point above the limit. Classification of a known population yields the statistical distribution of each parameter so that a deviation may be offset by other favorable factors, at a level that is suited to the actual age and gender of the applicant. Additionally, the applicant may have a minor medical condition that requires more favorable risk factors than those with no medical conditions.

In another aspect, the invention is directed to a method of auditing insurance underwriting performance. The method can include the steps of providing an interface to a user configured to aid in programming a set of risk assessment rules and receiving underwriting sample data indicative of a plurality of actual insurance applicants. The risk assessment rules define a plurality of preferred categories for an insurance product. The data includes the actual underwriting category associated with the applicant. The method can also include the steps of applying the risk assessment rules to the sample data, assigning each of the plurality of actual applicants to one of the preferred categories creating an automated category assignment, and comparing the automated category assignment to the actual category assignment.

In various embodiments, the method can also include the step of quantifying a cost of error when there is a discrepancy between the programmed category assignment and the actual category assignment. The method can also derive a mortality estimate for each of the plurality of actual applicants. An error pattern determination can be made based on the actual category assignment for the underwriting samples.

The foregoing and other features and advantages of the present invention will become more apparent in light of the following detailed description of the preferred embodiments thereof, as illustrated in the accompanying figures. As will be realized, the invention is capable of modifications in various respects, all without departing from the scope of the invention. Accordingly, the drawings and the description are to be regarded as illustrative in nature, and not as restrictive.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown. The drawings are not necessarily to scale, emphasis instead being placed on illustrating the principles of the present invention.

FIG. 1 is a flow chart depicting a method of practicing one embodiment of the present invention.

FIG. 2 is a flow chart depicting an embodiment of the deriving mortality step of FIG. 1.

FIG. 3 is a flow chart depicting a method of practicing one embodiment of the present invention.

FIG. 4 is a flow chart depicting a method of practicing one embodiment of the present invention.

FIGS. 5A-5E are tables providing one example of preferred class definitions that might be specific to a client.

### DETAILED DESCRIPTION OF THE PREFERRED EMBODIMENTS

In the drawings, in which like numerals indicate like elements, there is shown various features of the present invention.

Risk assessment rules are used by underwriters to classify applicants for an insurance product (e.g., life insurance). Various factors may be used when determining risk. These factors can include, age, weight, build, gender, family medical history, present physical condition, blood pressure, results of various blood and urine test, total cholesterol, HDL cholesterol, tobacco use, driving record, occupation, travel history, avocations, citizenship, place of residence, history of drug use, history of alcohol use, etc. The premium price for the insurance product is directly related to the risk classification of the applicant. For example, an applicant whose risk factors predict a higher mortality risk (i.e., a high risk applicant) will pay a higher premium than an applicant whose risk factors predict lower mortality risk (i.e., a low risk applicant).

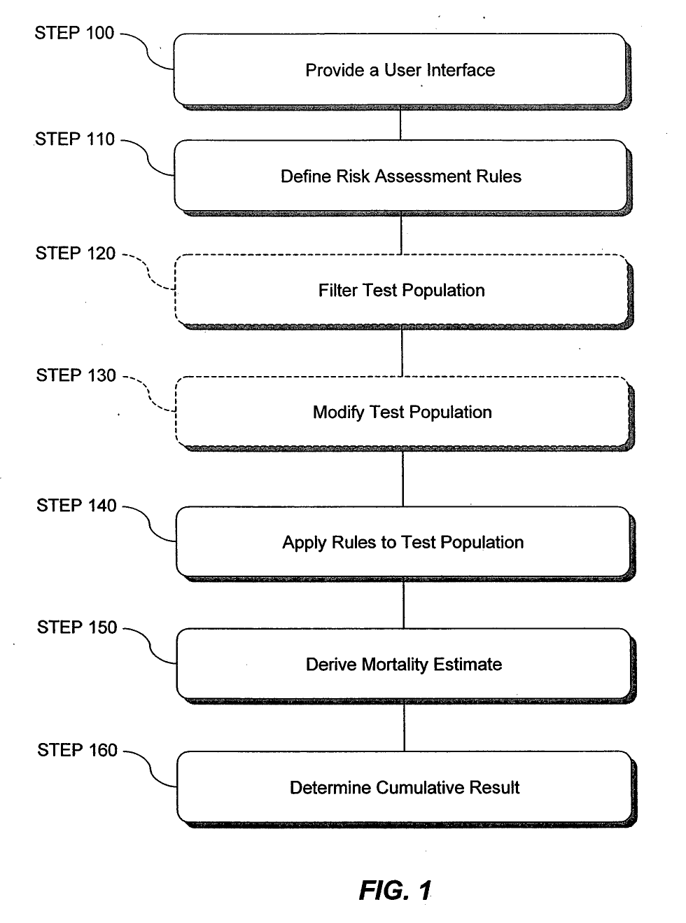

With reference to FIG. 1, one aspect of the invention relates to a method of evaluating a set of risk assessment rules for an insurance product. The method can be embodied as part of a software based system that is programmed into a computer readable medium. A programming language such as C++ or Java can be used as well as many others. The software can be executed in various conventional ways, such as on a central processor or distributed (remote or portable) processors that are located a various points on a computer network. The system includes a user interface that is displayed to a user (STEP 100). The user interface facilitates the programming of the risk assessment rules (STEP 110). The rules can be translated from the user interface into database queries or other machine readable formats. The user interface can be displayed on a LAN, WAN or other type of network workstation, as well as on a stand alone (desktop or portable) computer. The user interface can be a graphical user interface that prompts the user to answer specific questions. The user interface can also be a web-based application that allows the user to work across the internet to program the rules. This is particularly useful if a client of a reinsurance company does not want to purchase the software but only wishes to evaluate a set of rules. The client can program the rules remotely or the rules can be supplied to the insurance company which then incorporates the rules into the system.

The risk assessment rules define a plurality of preferred categories for an insurance product. For example, a term life insurance product can have preferred categories, such as standard, preferred, and ultra preferred. An example of risk assessment rules that define preferred categories are described in “Prediction of Coronary Heart Disease Using Risk Factor Categories,” P. Wilson, et al., National Heart, Lung, and Blood Institute (1998) which is incorporated herein by reference in its entirety. The premium price varies according to the preferred category. For example, the premium for the preferred category, based on a specific gender and age of the applicant, can be $50 a month, while the premium for an applicant of the same age and gender in the standard category can be in excess of $150 a month.

After the risk assessment rules are programmed, the rules are applied to a test population (STEP 140). The test population includes a plurality of members representative of insurance applicants. Each member has parameters (i.e., information data) that are collected through a variety of means, including an application process. Examples of the type of information collected on the test population include, for example, demographic information, paramedical information, and laboratory results are stored and associated with each member of the test population. The demographic information may include age, gender, the insurance product applied for, and the amount of coverage requested. The paramedical information can include height, weight, and blood pressure. The laboratory results can include blood chemistry information (e.g., total cholesterol and HDL cholesterol) and a urine analysis that includes a tobacco use assessment. All this information is included as part of the personal health data associated with a member of the population.

The test population can be related to actual human beings. For example, information acquired during a clinical study can be used to create a test population. Another source of such information is LabOne, Inc. located in Lenexa, Kans., which provides anonymous specific individual measures on each customer of LabOne during a calendar year. The data includes particular information on each member of the population (individual member data), which can then be used to perform the risk assessment. For example, the information may include age, sex, amount insured, insurance product applied for, state of residence, health history, height, weight, blood pressure, laboratory tests, motor vehicle record (MVR), avocations, occupation, citizenship, family history (health, ethnic, etc.) and the like.

Modifying the test population is optional (STEP 130) and should be performed prior to applying the risk assessment rules to the test population when policy pricing studies are being performed. If some of the parameters required to perform a risk assessment are missing they can be simulated for the test population. For example, if MVR data is not available in the database test population, actual industry data can be obtained that describes the distribution and prevalence of actionable driving history by age and sex. That actual MVR data is then randomly assigned to the test population to match the distribution of the real data. For example, if 2% of males age 20-25 have records that call for adverse action, this distribution can be simulated by adding a MVR parameter to the test population that randomly creates that status at a rate of 2%. The rate can vary based on numerous parameters, including age and sex. Additionally, for alcohol-related offenses, the rate can be adjusted according to the urine test for tobacco (cotinine), to reflect the known positive correlation between alcohol and tobacco use. The overall test population segment would reflect the 2% rate, but smokers would reflect a higher rate and non-smokers a lower rate. Demographic statistics on avocation and occupation for the general population facilitate analogous modeling. Industry statistics provide insight on citizenship or foreign residency. Data indicative of family history of medical conditions can be obtained from a client or in the medical literature. Random assignment could reflect known and measured risk factors. For example, the distribution of family history of heart attack can be weighted to correlate positively with blood pressure and cholesterol.

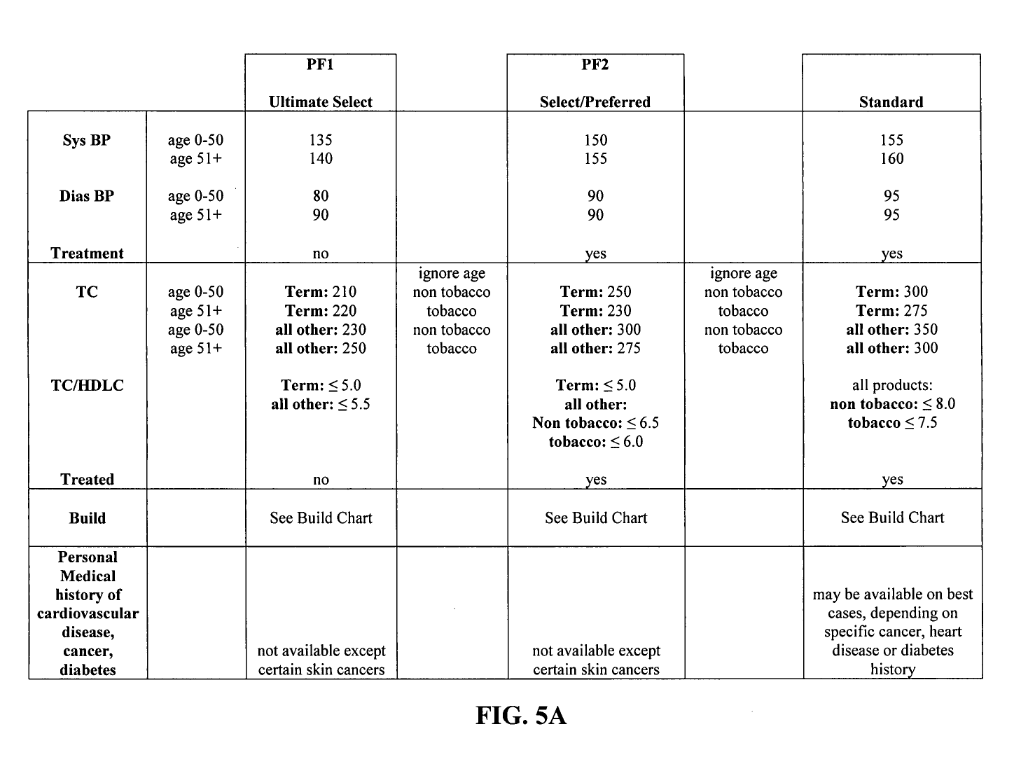

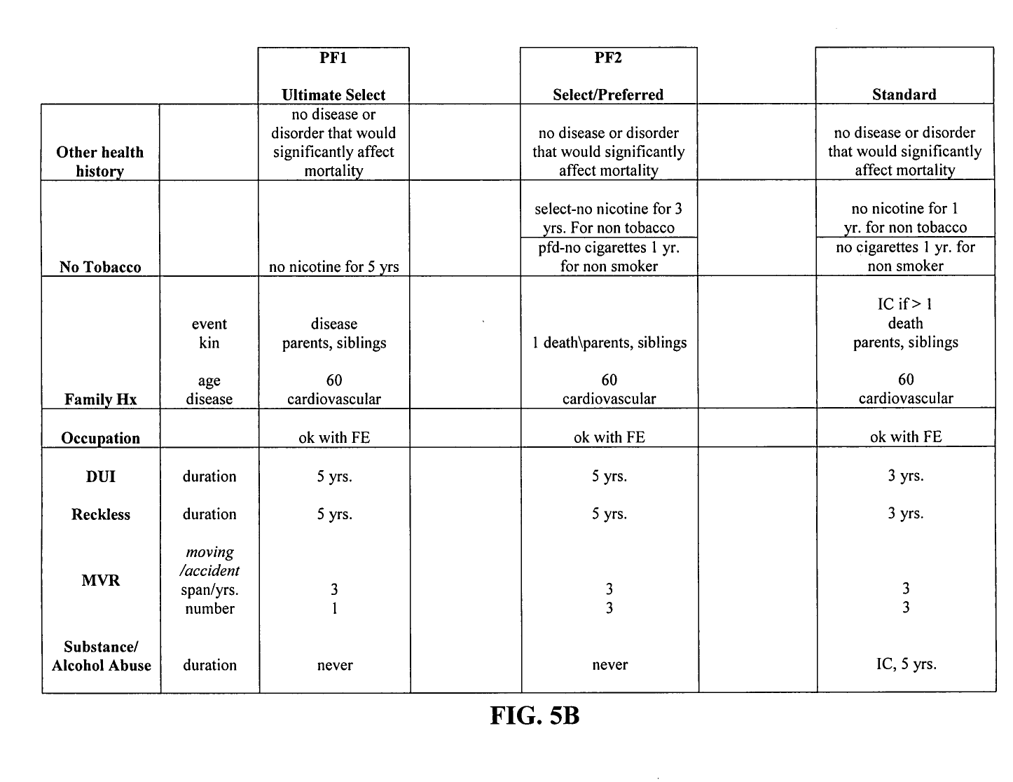

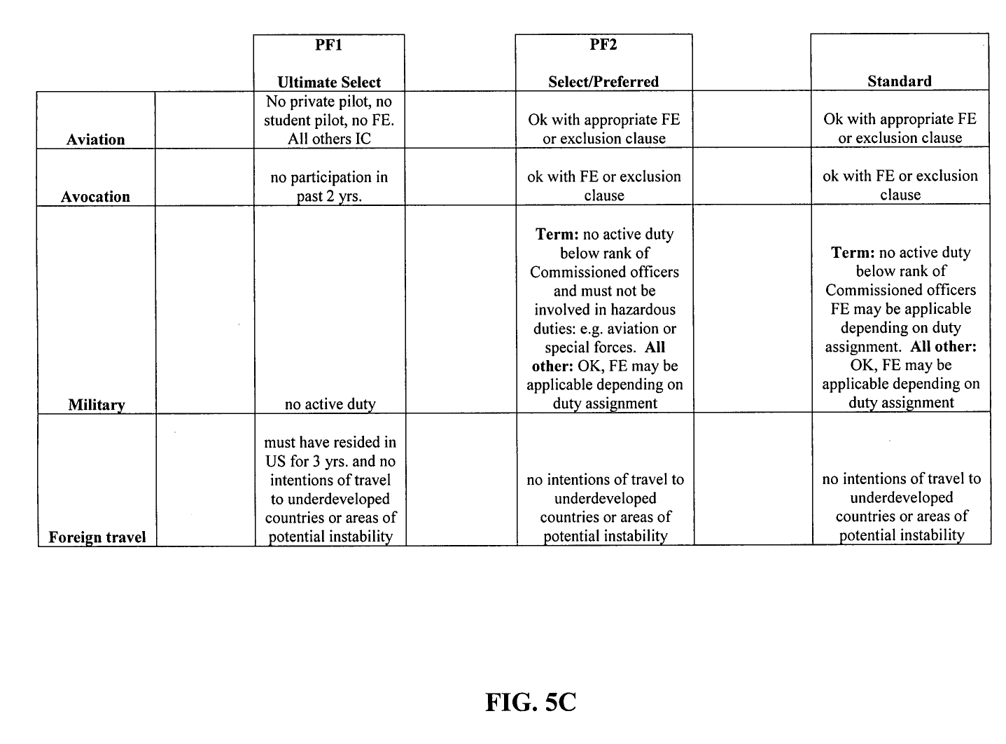

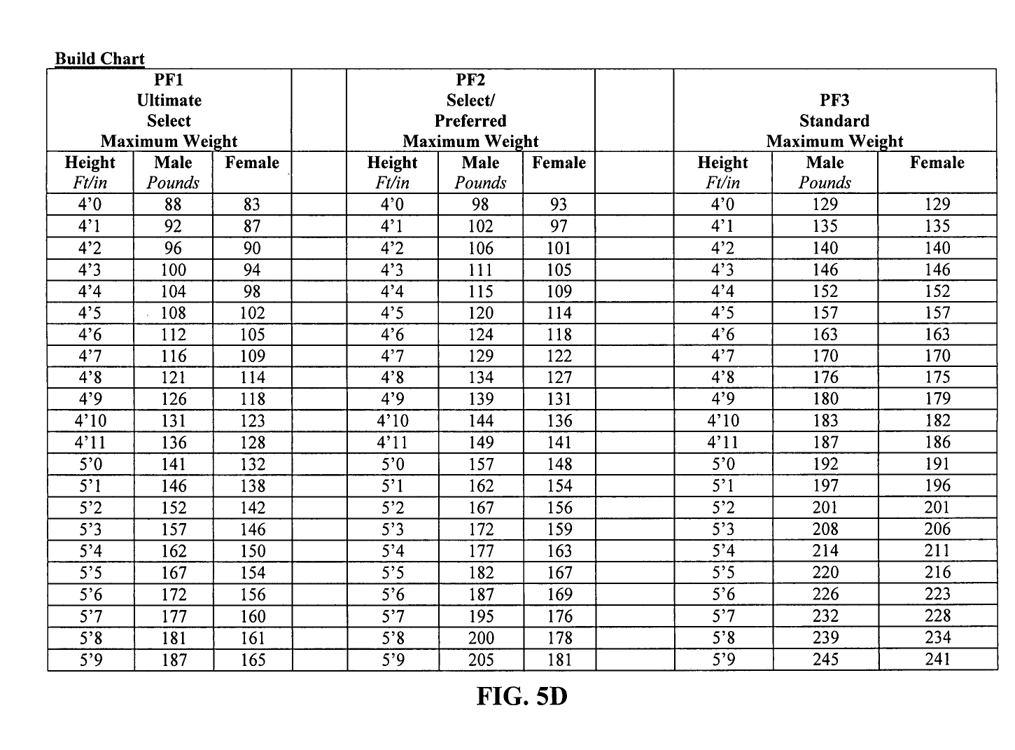

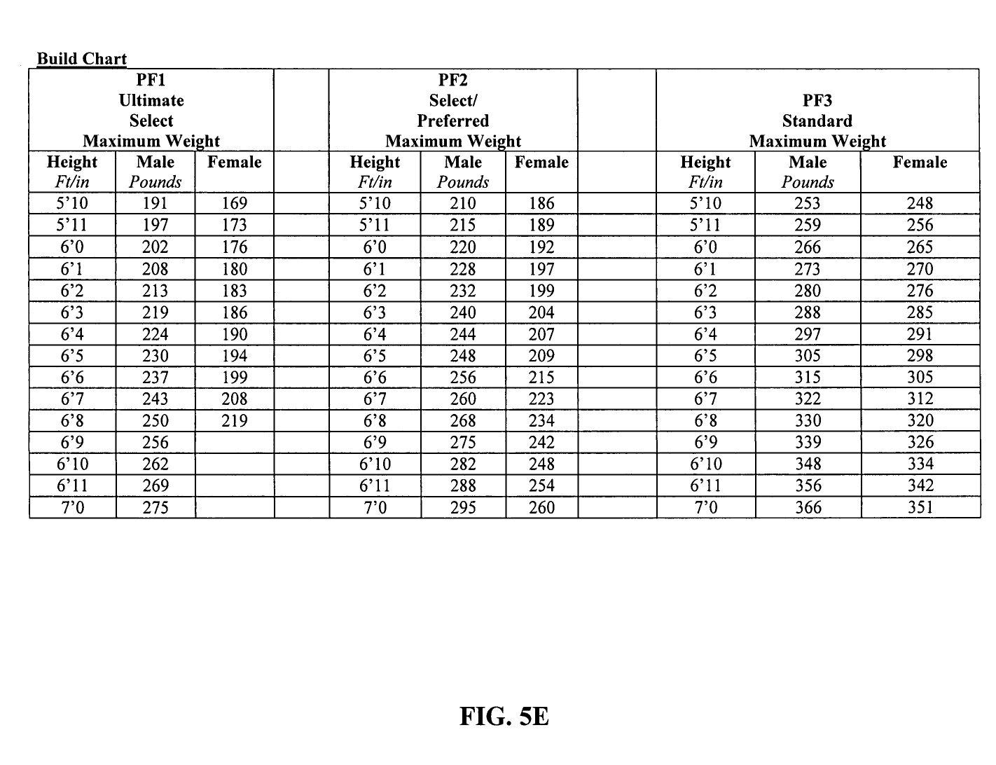

Prior to applying the risk assessment rules, the test population can be filtered (STEP 120). Filtering the test population improves the approximation of the test population to an actual insured population, to which the risk assessment rules are applied. The filtering step creates a subset of the test population. One example of filtering can include limiting the applicant pool to those eligible for the preferred classification based on either industry norms or client specific requirements. For example, any applicant with blood glucose greater than 200 is diabetic and is not included in the subset of the test population that would likely be subject to preferred classification. FIGS. 5A-5E provide one example of preferred class definitions that might be specific to a client and that can be used to formulate the rules in the program.

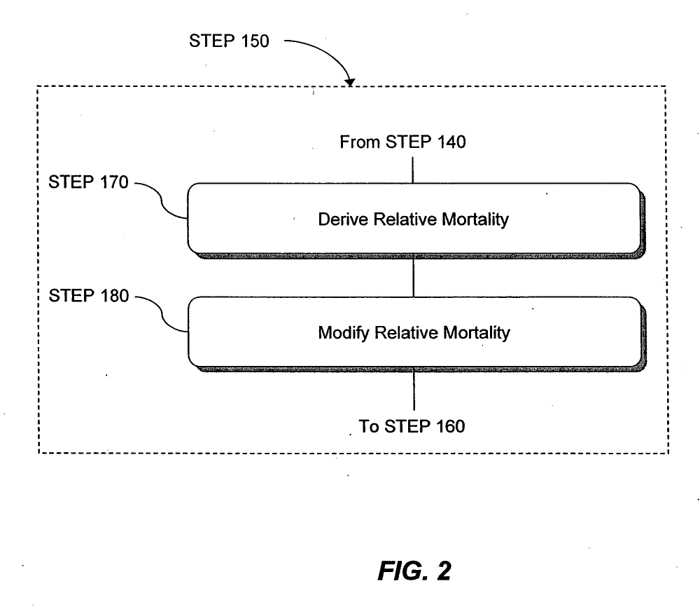

After the risk assessment rules are applied to the test population, the test population is sorted into specific preferred categories for the insurance product. An example of a method that can be used to perform the sorting step can be found in “Estimating Coronary Heart Disease (CHD) Risk Using Framingham Heart Study Prediction Score Sheets” which is incorporated herein by reference in its entirety. After classification, a mortality estimate for each member of the test population is preferably derived (STEP 150). More specifically, with reference to FIG. 2 a relative mortality for each member of the test population is derived (STEP 170) and then the relative mortality is modified (STEP 180).

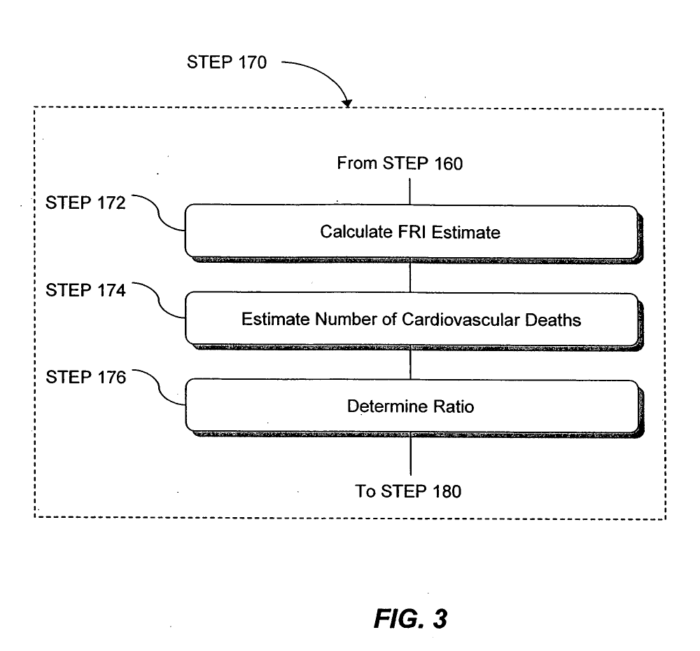

The relative mortality calculation is explained with reference to FIG. 3. One component of a method to estimate the relative mortality of an applicant could be the Framingham Risk Index (FRI) 10-year cardiac morbidity prediction. The details of the Framingham Risk Index are available from the National Heart, Lung, and Blood Institute, at www.nhlbi.nih.gov/about/framingham/index.html. The Framingham Risk Index is incorporated herein by reference in its entirety. Using the index, the 10-year risk of an applicant having a cardiac event, such as angina, bypass surgery, angioplasty, and death due to ischemic heart disease, is calculated for each member of the test population. An estimate is made as to the number of deaths that will result from the number of these cardiac events. The estimate, which is referred to as the FRI mortality estimate, is a fraction of the number of the events (STEP 172). For example, an individual's expected risk is determined using the FRI test. Next, using the mortality analysis below, an assessment is made of each individual relative to the comparative risk. An individual may be assessed as being a percentage above or below the comparative risk. For example, an individual may be determined as having 150% of the comparative risk. The comparative risk is determined by calculating the average mortality risk for the entire test population and the average for each subset population (i.e., each preferred risk category). The ratio of these averages (each subset (preferred risk category) to the whole) provides the comparative risk.

The number of cardiovascular deaths expected over a 10 year cumulative period for the members of an actual insured population, matched by age and sex, is calculated (STEP 174). This calculation may be performed by taking a mortality estimate from an industry mortality table, such as Society of Actuaries (SOA) 7580. The number of cardiovascular deaths is estimated by applying National Center for Health Statistics table of death by cause to the SOA 7580 table. The result is referred to as the NCHS/SOA mortality. The relative mortality is the ratio of the FRI mortality to the NCHS/SOA mortality (STEP 176).

Next, the average mortality for each risk category is determined. Risk class mortality is calculated as the total class mortality divided by the aggregate standard subset mortality (i.e., the mortality for a preferred risk category.) In other words, the mortality for each class is normalized with respect to the aggregate standard subset mortality. This result can be stratified by gender and age. In another embodiment, an alternative method is used to calculate the relative mortality. The relative mortality is calculated as the ratio of the FRI average for a risk class to the FRI average mortality of the standard aggregate subset.

Various factors may be used to modify the relative mortality (STEP 180) to create a cumulative result (160). Assignment of underwriting mortality estimates for known parameters such as build, blood pressure, lab test results are applied according to preprogrammed underwriting guidelines. For example, an individual's build can have a positive or negative impact on an individuals' mortality, e.g., studies show that a body mass index (BMI) either less than 18.5 or greater than 30 indicates higher mortality than for a BMI in the normal range (between 18.5 and 25). As such, the extra mortality data from all individuals in a risk class can be summed and averaged over the risk class. Also the measurement of average body mass index (BMI) and systolic blood pressure, expressed as ratio to average value for aggregate standard, stratified by, for example, the individuals' decade of age and by sex, can be used to adjust the mortality estimate. The final mortality measurement reflects a weighted average of these mortality factors by age, sex (gender), and underwriting class.

For example with reference to the table below, assume for males age 30-39 that 38% of the aggregate standard risk subset is classified into the lowest mortality class, FRI relative mortality is 97% of the aggregate standard subset, impairment rating is 99%, BMI is 90% and systolic blood pressure is 96%. The overall mortality assessment is 92% of aggregate standard for this situation. The following table depicts a sample output, for all ages, and both sexes. The cells representing the “average” data come from the application of client underwriting rules to the test population. The cells representing the “relative” data are in the form (preferred classification/aggregate standard) in percentage terms. Mortality Rate (MR) refers to the FRI calculation. Relative Q expresses the MR+0.3(relative systolic blood pressure)+0.3(relative build)+relative debits.

TABLE 1

| | PF1 | PF2 | Res STD | Agg Std |
|---|---|---|---|---|
| Number of Applicants | 136,735 | 131,962 | 137,168 | 405,865 |
| % of Applicants | 34% | 33% | 34% | 100% |
| Average Systolic BP | 112 | 117 | 120 | 116 |
| Relative Systolic BP | 96% | 101% | 103% | 100% |
| Average BMI | 23.0 | 25.9 | 29.9 | 26.3 |
| Relative BMI | 88% | 99% | 114% | 100% |
| Average MR | 100 | 102 | 108 | 104 |
| Relative MR | 97% | 98% | 104% | 100% |
| Average debits | 1.0 | 1.8 | 4.1 | 2.3 |
| Relative debits | 99% | 99% | 102% | 100% |
| RELATIVE Q | 91% | 98% | 112% | 100% |

Once the cumulative results are obtained, the information can be used in various ways. For example, one use of particular interest is as an audit protocol. More particularly, the results of the analysis can be used to audit a client's underwriting activities. Also, the results can be used to determine an error pattern in underwriting activities as well as suggest changes to the risk classification rules. Another use is to project the cost of insurance of each subclass created by a given set of underwriting rules.

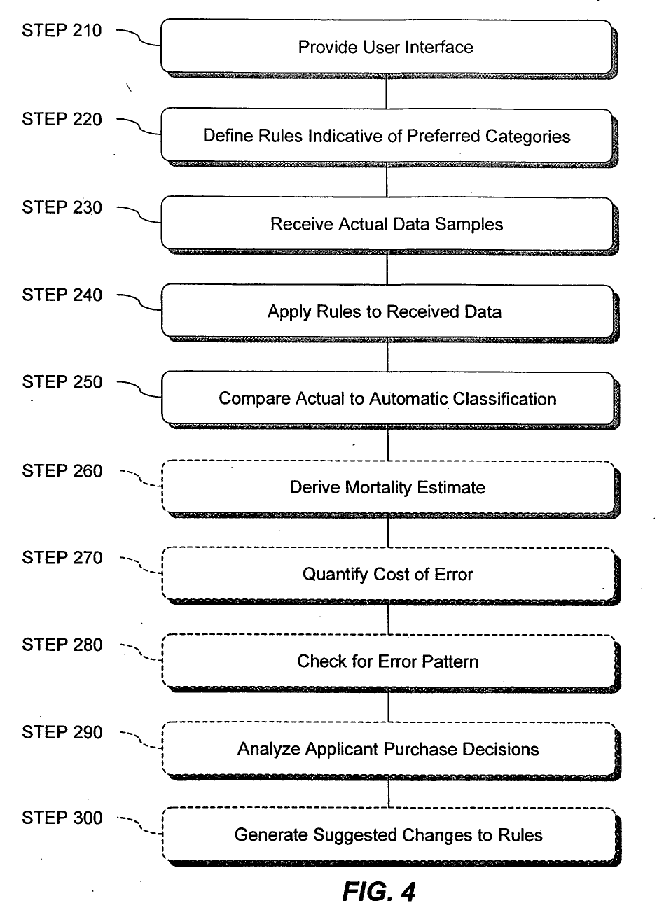

With reference to FIG. 4, an insurance company may wish to audit the performance of a group of underwriters or an individual underwriter. The audit can determine how closely the underwriter is adhering to the risk classification rules. To begin, the user interface is provided to a user (STEP 210). The user inputs the risk classification rules (STEP 220) (or the rules may have been previously inputted, downloaded or stored). The risk classification rules define the plurality of preferred categories for an insurance product. Next, a select sample of actual underwriting data is provided (STEP 230). The data includes the actual information processed by the underwriter(s)/company being audited. As such, each sample would preferably include all the parameters that are considered by the risk classification rules. The sample data also includes information related to the amount of coverage applied for, the preferred category assigned to the applicant, and whether or not the applicant decided to purchase the policy. Statistical calculations are used to facilitate the determination of the sample size required for detection of any desired level of error rate, and the level of confidence in the sample size required. For example, allowing an error rate of 3% may require an audit size of 851 cases. A typical manual audit involves less than 100 cases, which is too few for an accurate determination of underwriter performance. The present invention permits larger sample sizes to be used in order to provide more accurate and faster results. The programmed risk classification rules are applied to the sample data (STEP 240) and each sample applicant is classified into one of the preferred categories. The actual underwriter category assignment is compared with the automatic category assignment (STEP 250). If there is a discrepancy between the two classifications, the record is flagged. The system can also be used to highlight what factors may have impacted the difference in classifications.

In an optional step, a mortality estimate is determined in the above-described manner (STEP 260) for each of the flagged samples. The cost of error, which is the cost of misclassifying the applicant by the underwriter, is calculated and reported (STEP 270). These optional steps can be used to help the insurance company illustrate the importance of adhering the classification rules. In addition to quantifying the cost of error, a check for an error pattern (STEP 280) can be performed. For example, analyzing the flagged samples can reveal a pattern, such as 65% of people who weigh 5 pounds greater than the limit required for the best preferred class are waived into the class. This error pattern can be determined for an individual underwriter or across a group of underwriters depending on the nature of the samples.

Another feature of the invention is to analyze the applicant purchase decisions (STEP 290) and suggest changes to the risk classification rules (STEP 300) to help an insurance company raise their purchase rate. By providing the customer with the sample data, the method identifies and characterizes segments that an insurance company loses to competitors or to consumer reaction. For example, the method can determine that requiring a systolic blood pressure less than 120 for preferred classification results in a “not taken” rate of 10% while requiring a systolic blood pressure below 115 increases the “not taken” rate to 20%. This information can be use to generate suggested changes to the risk assessment rules to increase the number of policies sold.

Generally, the system described herein can be used to provide a number of automated features that were previously preformed manually or were not accounted for due to the inability to accurately and efficiently take into account certain factors. For example, the system can provide new quote pricing. A client company submits definition to the system for number of preferred risk segments of the aggregate standard risk pool. The system applies the definition against the available parameters of a synthetic population (simulated underwriting). The system output is a projection, subdivided for age band and gender, of the expected distribution among preferred risk classes. Another output is the projection of mortality rate in each class and band relative to total surrogate population projected mortality rate.

Another feature of the system is to provide underwriting fine-tuning. Underwriting guidelines address one or more parameters, and assign a risk class. For example, certain cases of asthma are standard mortality risk, and the remainder are higher risk and require a higher premium price for the same amount of coverage. Other parameters, such as build, blood pressure, and cholesterol ratio are not germane to the decision about asthma. In both standard and substandard asthma populations, the spectrum of cardiovascular parameters corresponds to a spectrum of mortality risk unrelated to the asthma risk.

The present invention also permits a standard risk case for a particular ailment to qualify for preferred pricing. The present invention does so by assessing the overall cardiovascular risk to determine if it is at least as good as the average (median) risk of the preferred pool. The present invention can determine the average (median) FRI and BMI of each age/sex in each preferred class according to any given set of preferred rules. The standard risk case for a particular ailment (such as asthma) can qualify for preferred pricing if the BMI, and FRI are each better than the expected median for the preferred class.

This can be referred to as Standard vs. Preferred (SVP). One example of a preferred SVP guideline which provide a method for classification of many impairments, with constraints for preferred eligibility, can be found in following section.

Standard vs. Preferred (SVP) Guidelines

The following guidelines address preferred classification of cases for mortality risk at the level of the Standard class. The following provide only one example of preferred guidelines for a client. Other guidelines may be used in the present invention depending on the client's needs.

Table 2 is an exemplary chart for associating categories with specific medical problems or ailments. Various other medical problems would be similarly tabulated and categorized.

TABLE 2

| Medical Problems | Category |
|---|---|
| Alcoholism, treated and recovered for over 10 years | B |
| ALT or AST or GGT (one only) <1.2 × normal | B |
| ALT, AST, GGT all <1.5 | C |
| Anemia | A |
| Pernicious, hematologically normal on treatment | |
| Iron deficiency in pre-menopausal women | |
| Women age <50 | |
| Anxiety or depression | |
| acute response to situational life stress, recovered, not on | A |
| treatment | |
| chronic response to normal life stress, equivalent to | B |
| condition that often does not lead to any medical condition, on | |
| current treatment with minimum dose of single drug | |
| Asthma | B |
| Blindness, unrelated to systemic disease | A |
| Breast hyperplasia | C |
| Atypical ductal hyperplasia (ADH) | |
| Atypical lobular hyperplasia (ALH) | |
| Cancer, all except basal and squamous cell carcinoma | D |
| of the skin | |
| Colitis, simple | A |

SVP Category A—Action: If applicant falls within this category, disregard medical problem and offer preferred class according to a client's existing guidelines as if the problem did not exist.

SVP Category B—Action: If the applicant falls within this category, substitute the limits for systolic blood pressure, cholesterol and BMI with the following chart. Applicant must meet all other client requirements for each class.

TABLE 3

| | Elite Preferred | | Super Preferred | | Preferred | |
|---|---|---|---|---|---|---|
| | Male | Female | Male | Female | Male | Female |
| Systolic BP | | | | | | |
| Age <50 | 120 | 110 | 125 | 120 | 125 | 120 |
| Age >50 | 125 | 120 | 130 | 125 | 130 | 125 |
| TC/HDL | | | | | | |
| All Ages | 3.5 | 3.0 | 4.0 | 3.5 | 4.5 | 4.0 |
| BMI | | | | | | |
| Age <50 | 25 | 24 | | | | |
| Age >50 | 26 | 25 | | | | |
| All Ages | | | 27 | 26 | 28.5 | 27 |

SVP Category C—Action: Substitute the limits for systolic blood pressure, cholesterol and BMI with the following chart. Applicant must meet all other client requirements for each class. Elite Preferred is not permitted.

TABLE 4

| | |
|---|---|
| Super Preferred | Preferred |

| | Male | Female | Male | Female |
|---|---|---|---|---|
| Blood Pressure | | | | |
| Not Treated | | | | |
| Age <50 | 120 | 110 | 125 | 120 |
| Age >50 | 125 | 120 | 130 | 125 |
| TC/HDL | | | | |
| All Ages | 3.5 | 3.0 | 4.0 | 3.5 |
| BMI | | | | |
| Age <50 | 25 | 24 | | |
| Age >50 | 26 | 25 | | |
| All Ages | | | 27 | 26 |

SVP Category D—Action: Allow Standard only, Preferred is not permitted.

It should be readily apparent that the benchmarks listed are exemplary and that these benchmarks can be refined into smaller age bands (e.g., yearly). Also, when implemented as part of a program with a user interface, the present invention can provide easy look-up and output of data for a set of input data.

Another embodiment of the same process generates “credits” for substandard cases. For conditions unrelated to cardiovascular risk, such as asthma, the population of applicants with the condition exhibits a spectrum of cardiovascular risk. Thus, typically, these applicants are assessed a higher premium due to this risk. The present invention accounts for this by assessing whether the medical problem (e.g., asthma) satisfies a set of cardiovascular risk requirements. If so the risk is adjusted. In one embodiment this adjustment is an adjustment (e.g., reduction) is the percentage increase associated with the individual's premium that was attributable to the medical problem. For example, if the applicant has asthma and, as such, the premium for that applicant is increased by 150% over a comparable person without asthma, if the applicant with asthma satisfies a set of cardiovascular risk requirements, that applicant's premium can be reduced by 25%. One set of preferred operational rules for conducting this aspect of the invention is as follows.

In order for the cardiovascular profile to offset the mortality of a rated impairment, the case should have cardiovascular risk as good or better than the average case in the aggregate standard class, and the incremental cardiovascular mortality should balance the incremental mortality of the rated impairment.

The present invention generates the median values of BMI and FRI for the aggregate standard risk pool. For impairments unrelated to cardiovascular disease, the distribution of these risk factors should be very similar. The following table is an example of the distribution. The age ranges can be broken down even more to provide a more accurate assessment.

TABLE 5

| | Median | | |
|---|---|---|---|
| Gender | Age | BMI | FRI |
| Male | <30 | A1 | C1 |
| | 30-39 | A2 | C2 |
| | 40-49 | A3 | C3 |
| | 50-59 | A4 | C4 |
| | 60-69 | A5 | C5 |
| | 70+ | A6 | C6 |
| Female | <30 | B1 | D1 |
| | 30-39 | B2 | D2 |
| | 40-49 | B3 | D3 |
| | 50-59 | B4 | D4 |
| | 60-69 | B5 | D5 |
| | 70+ | B6 | D6 |

### EXAMPLE

### Cardiovascular Risk Factor Credit for Substandard Cases

Applies to substandard cases for non-tobacco applicants, ages 18 to 70. In this example, the credit is not applied to cases with impairments that present short-term risk of trauma, pre-existing cardiovascular disease, and advanced age, such as substance abuse, psychiatric impairments, seizure disorder, cancer, cerebrovascular disease, coronary artery disease, peripheral vascular disease and diabetes mellitus.

In order to calculate the cardiovascular risk associated with a particular applicant, the following data is inputted: Age, Gender, Height, Weight, Systolic blood pressure, Diastolic blood pressure, Total cholesterol, and HDL cholesterol. BMI and Framingham Risk Index are determined based on these inputs. BMI is determined as follows:

$$BMI = \frac{Weight ( pounds ) / 2.2}{{( Height ( inches ) \times 0.254 )}^{2}} \qquad Equation 1$$

The Framingham Risk Index is calculated using conventional equations which are published as part of the Framingham study associated with the index. (The Framingham Risk Index calculation is well know to those skilled in the art and is incorporated herein by reference in its entirety.) If the values for BMI and Framingham Risk Index fall below the median for the age and gender in the aggregate standard population, the Cardiovascular Risk Factor Credit is −25. Thus, in this example, the credit would apply to situations where the applicant's cardiovascular risk factor is better than the median (50%) of the aggregate standard population. This calculation simulates preferred underwriting. The Framingham Risk Index consolidates blood pressure and TC/HDLC into a single variable. This method uses universally available quantitative data, so is more consistent and systematic than conventional guidelines. This method also eliminates the need to consider exercise fitness, family history, and PFT since those factors are often unknown.

In one exemplary calculation, for a male, age 35, the following data was used:
Height=6 feet, Weight=180 pounds Total cholesterol=250 mg/dl, HDL cholesterol=65 mg/dl Systolic Blood Pressure=120 mm Hg, Diastolic Blood Pressure=80 mm Hg

The calculated BMI for the applicant is 24.5 and the FRI is 1.52% risk of a coronary event in the next 10 years. The median BMI for the standard population is 27.1 (based on an analysis of the standard population for the preferred class using Equations 1), and the FRI for the standard is 1.683% (based on an analysis of the standard population for the preferred class using conventional FRI calculations.) Since the values for the applicant are less than the median of the standard population for the applicant's gender and age, the applicant is given a credit of −25. This is applied as a credit to the applicant's supplemental premium that was assessed due to a medical problem associated with the applicant. While the present invention uses 25 as the adjustment, other adjustments can be used depending on the medical problem and its relationship to cardiovascular risk.

Another embodiment addresses “exceptions” to the preferred criteria. If an applicant misses preferred pricing on only a single parameter, can the underwriter allow preferred categorization of the applicant? The system can include a margin above the preferred limit (e.g., 5 pounds above the build limit). If the blood pressure and cholesterol ratio fall below the median for the same age and sex in the preferred class, preferred pricing is allowed.

Although the invention has been described as being used in connection with life insurance, the teachings herein can also be used to evaluate and classify applicants for automobile insurance, disability insurance, health insurance and other types of insurance.

The present invention has been described as a software system. However, it should be understood that the present invention can also be implemented as hardware that performs the various functional aspects described.

As noted above, a variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method of evaluating a set of risk assessment rules for an insurance product comprising the steps of:
providing a set of risk assessment rules, the risk assessment rules defining a plurality of preferred categories for an insurance product;
applying the risk assessment rules to at least a portion of a test population having a plurality of members to generate a classified population;
deriving a mortality estimate for each member of the classified population; and
determining a cumulative result for each preferred category.

2. The method of claim 1 further comprising the step of filtering the test population to create a subset thereof, the subset being the portion of the test population that the risk assessment rules are applied to.

3. The method of claim 1 wherein the step of deriving a mortality estimate comprises the steps of deriving a standard mortality estimate and modifying the standard mortality estimate in response to at least one parameter associated each member of the classified population.

4. The method of claim 1 further comprising the step of modifying the test population to include at least one parameter in addition to a set of parameters associated with the original test population.

5. The method of claim 4 wherein the at least one parameter is correlated to mortality.

6. A method of auditing insurance underwriting performance comprising the steps of:
providing a set of risk assessment rules, the risk assessment rules defining a plurality of preferred categories for an insurance product;
receiving underwriting data indicative of a plurality of actual insurance applicants, the data including the actual category assignment associated with each actual insurance applicant;
applying the risk assessment rules to the underwriting data;
assigning each actual insurance applicant to one of the preferred categories in response to the applying step to create an automated category assignment; and
comparing the automated category assignment to the actual category assignment for each actual insurance applicant.

7. The method of claim 6 further comprising the step of quantifying a cost of error when there is a discrepancy between the automated category assignment and the actual category assignment.

8. The method of claim 6 further comprising the step of deriving a mortality estimate for each of the plurality of actual insurance applicants.

9. The method of claim 6 further comprising the step of determining if an error pattern exists in the actual category assignment for the underwriting data.

10. The method of claim 6 wherein the underwriting data further comprises information related to a purchase decision for an insurance product by the applicant.

11. The method of claim 10 further comprising the step of analyzing a set of the actual insurance applicants whose purchase decision was to decline to purchase the insurance project.

12. The method of claim 11 further comprising the step of determining a modification to the risk assessment rules in response to the analysis step.

13. A method of evaluating a set of risk assessment rules for an insurance product comprising the steps of:
providing a set of risk assessment rules, the risk assessment rules defining a plurality of preferred categories for an insurance product and threshold values for a plurality of applicant related data for each category;
applying the risk assessment rules to at least a portion of a test population having a plurality of members to generate a classified population;
deriving a mortality estimate for each member of the classified population; and
determining a cumulative result for each preferred category;
receiving underwriting data indicative of a plurality of actual insurance applicants, the data including the actual category assignment associated with each actual insurance applicant;
applying the risk assessment rules to at least a portion of the underwriting data;
assigning each actual insurance applicant to one of the preferred categories in response to the applying step to create an automated category assignment; and
comparing the automated category assignment to the actual category assignment for each actual insurance applicant.

14. A method of evaluating a set of risk assessment rules for an insurance product comprising the steps of:
providing a set of risk assessment rules for associating applicants for insurance into preferred risk categories;
providing test population data associated with a plurality of individual members, the test population data including a plurality of personal health data associated with each member;
applying the risk assessment rules to at least a portion of the test population data; and
sorting the members into specific preferred categories based on the application of the risk assessment rules.

15. The method of evaluating a set of risk assessment rules according to claim 14 further comprising the step of determining a mortality estimate for at least a portion of the members of the test population data.

16. The method of evaluating a set of risk assessment rules according to claim 15 further comprising the step of determining an average mortality for each risk category based on the mortality estimate of the members.

17. The method of evaluating a set of risk assessment rules according to claim 16 further comprising the steps of receiving actual applicant data; analyzing the actual applicant data for categorizing the actual applicants into the preferred risk categories; determining an average mortality estimate for each of the preferred risk category for the actual applicants, and comparing the average risk category mortalities for the test population against the actual applicants.

18. The method of evaluating a set of risk assessment rules according to claim 17 further comprising the step of determining an error pattern in underwriting activities associated with the actual applicants based on the comparison of the average mortalities.

19. The method of evaluating a set of risk assessment rules according to claim 16 further comprising the step of determining an adjustment to the risk classification rules.

20. The method of evaluating a set of risk assessment rules according to claim 16 further comprising the step of determining a cost of insurance associated with each preferred risk category based on the average mortality.

21. The method of evaluating a set of risk assessment rules according to claim 15 wherein the step of determining a mortality estimate involves calculating a risk factor associated with each member in a preferred category having a cardiac event within a period of time in the future; and determining an estimate of the mortality for the category as a portion of the cardiac event risk factors.

22. The method of evaluating a set of risk assessment rules according to claim 21 wherein the step of determining a mortality estimate further comprises the step of determining the number of cardiovascular deaths expected over a cumulative period for the members of an actual insured population and determining a relative mortality as a ratio of the FRI mortality estimate to the mortality estimate that is based on the actual insured population.

23. The method of evaluating a set of risk assessment rules according to claim 15 further comprising the step of modifying the mortality estimate for the members.

24. The method of evaluating a set of risk assessment rules according to claim 23 wherein the step of modifying the mortality estimate for the members involves adjusting an member's mortality estimate based on select data associated with the member's health which have a correlation with mortality.

25. The method of evaluating a set of risk assessment rules according to claim 24 wherein the select data includes at least the member's body mass index.

26. The method of evaluating a set of risk assessment rules according to claim 14 further comprising the step of filtering the test population data based on at least one personal health data parameter to create a subset of the test population data.

27. The method of evaluating a set of risk assessment rules according to claim 14 further comprising the steps of:
determining if the test population data includes all of the personal health data required by the risk assessment rules; and
modifying the test population data to include additional personal health data that was determined to be missing from the test population data for each individual member.

28. The method of evaluating a set of risk assessment rules according to claim 27 wherein the additional health data is acquired from other historical population data.

29. The method of evaluating a set of risk assessment rules according to claim 27 wherein the additional health data is simulated using other historical population data.
